(19) United States
(12) Patent Application Publication
(10) Pub. No.: US 2016/0347278 A1
(43) Pub. Date: Dec. 1, 2016

(54) Child Safety Assembly

(71) Applicant: Mack Bibbs, JR., Bessemer, AL (US)

(72) Inventor: Mack Bibbs, JR., Bessemer, AL (US)

(21) Appl. No.: 14/721,794

(22) Filed: May 26, 2015

(51) Int. Cl. B60R 22/48; B60R 22/10; A44B 11/25; B60Q 9/00

(52) U.S. Cl. CPC B60R 22/48; B60Q 9/00; B60R 22/105; A44B 11/2569; A44B 11/2511; B60R 2022/4816; B60R 2022/4808; B60R 2022/4866

(57) ABSTRACT

A child safety assembly includes a housing that may insertably receive a male end of a vehicle seatbelt. A buckle is attached to the housing such that the buckle may engage a female end of the vehicle seatbelt. Thus, the housing is retained between the male end of the vehicle seatbelt and the female end of the vehicle seat belt when the vehicle seatbelt is utilized to restrain a child in the vehicle. A detection unit is positioned within the housing. The detection unit is in communication with the vehicle such that the detection unit detects when the vehicle is turned on and off. The detection issues an audible alarm such that the detection unit prevents a child from being left within the vehicle after the vehicle is turned off.

### BACKGROUND OF THE DISCLOSURE

### Field of the Disclosure

The disclosure relates to safety devices and more particularly pertains to a new safety device for preventing a child from being inadvertently left in a vehicle.

### SUMMARY OF THE DISCLOSURE

An embodiment of the disclosure meets the needs presented above by generally comprising a housing that may insertably receive a male end of a vehicle seatbelt. A buckle is attached to the housing such that the buckle may engage a female end of the vehicle seatbelt. Thus, the housing is retained between the male end of the vehicle seatbelt and the female end of the vehicle seat belt when the vehicle seatbelt is utilized to restrain a child in the vehicle. A detection unit is positioned within the housing. The detection unit is in communication with the vehicle such that the detection unit detects when the vehicle is turned on and off. The detection issues an audible alarm such that the detection unit prevents a child from being left within the vehicle after the vehicle is turned off.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a child safety assembly according to an embodiment of the disclosure.

FIG. 2 is a bottom view of an embodiment of the disclosure.

FIG. 3 is a back view of an embodiment of the disclosure.

FIG. 4 is a perspective in-use view of an embodiment of the disclosure.

FIG. 5 is a schematic view of an embodiment of the disclosure.

### DESCRIPTION OF THE PREFERRED EMBODIMENT

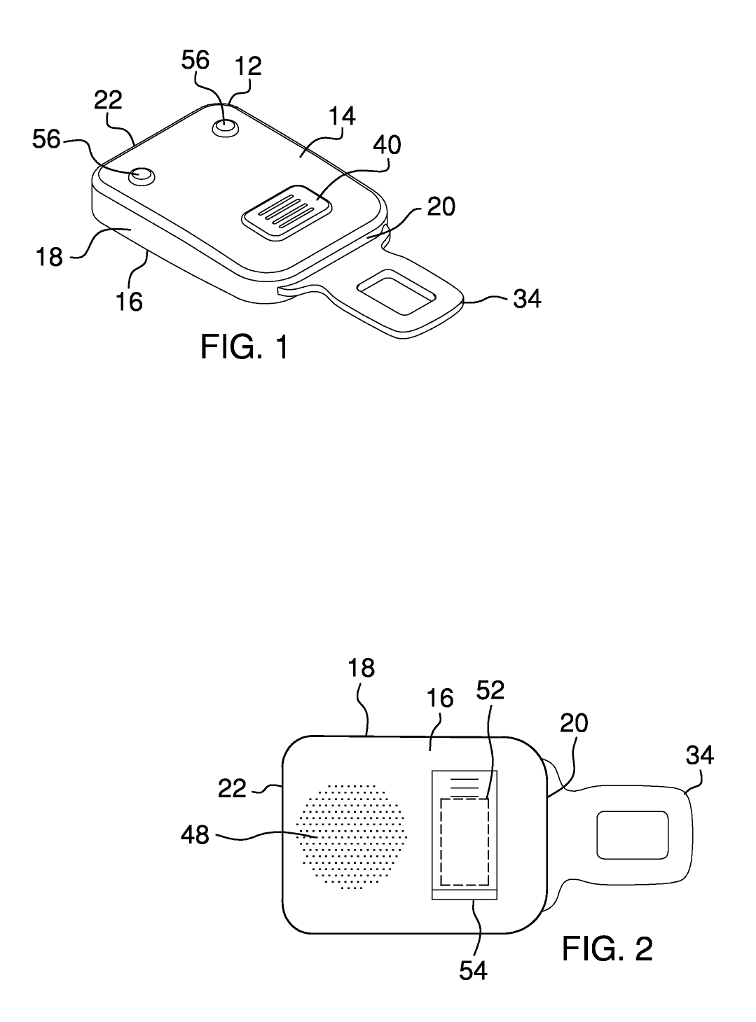

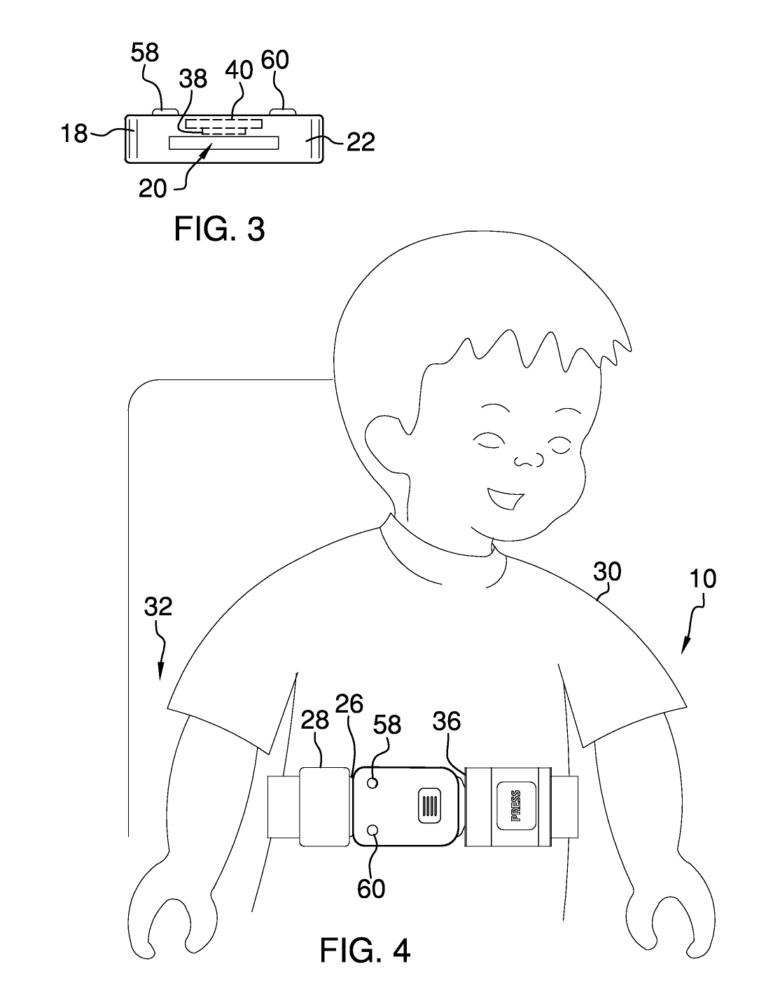

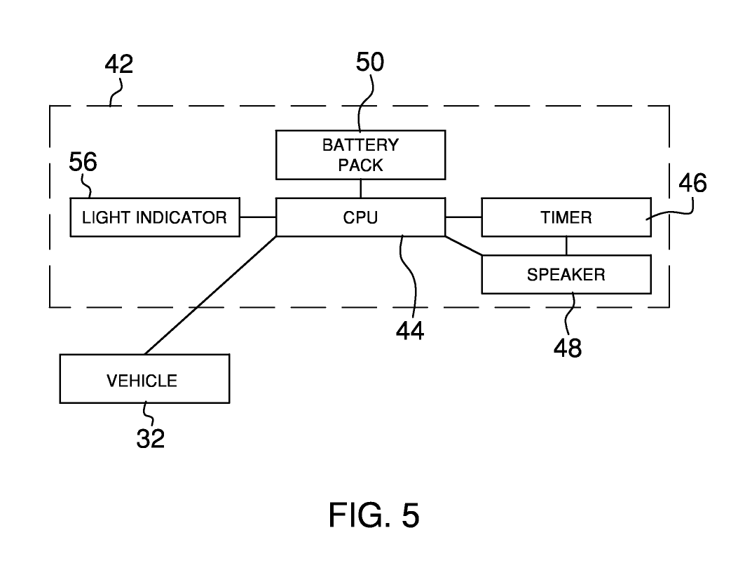

With reference now to the drawings, and in particular to FIGS. 1 through 5 thereof, a new safety device embodying the principles and concepts of an embodiment of the disclosure and generally designated by the reference numeral 10 will be described.

As best illustrated in FIGS. 1 through 5, the child safety assembly 10 generally comprises a housing 12 that has a top wall 14, a bottom wall 16 and a peripheral wall 18 extending between the top wall 14 and the bottom wall 16. The peripheral wall 18 has a front side 20 and a back side 22 and the back side 22 has a well 24 extending inwardly therein. Thus, the well 24 may insertably receive a male end 26 of a vehicle seatbelt 28. The vehicle seatbelt 28 may be used to restrain a child 30 within a vehicle 32. The vehicle 32 may be a passenger vehicle or the like.

A buckle 34 is attached to the housing 12 and the buckle 34 is positioned on and extends away from the front side 20 of the housing 12. Thus, the buckle 34 may engage a female end 36 of the vehicle seatbelt 28. The housing 12 is retained between the male end 26 of the vehicle seatbelt 28 and the female end 36 of the vehicle seatbelt 28 when the vehicle seatbelt 28 is utilized to restrain the child 30 in the vehicle 32.

A lock 38 is coupled to the housing 12 such that the lock 38 may engage the male end 26 of the vehicle seatbelt 28 thereby removably coupling the vehicle seatbelt 28 to the housing 12. A release 40 is coupled to the housing 12 and the release 40 is positioned on the top wall 14 such that the release 40 may be manipulated. The release 40 is mechanically coupled to the lock 38 such that the release 40 may release the male end 26 from the housing 12 when the release 40 is manipulated.

A detection unit 42 is positioned within the housing 12 and the detection unit 42 is in communication with the vehicle 32 such that the detection unit 42 detects when the vehicle 32 is turned on and off. The detection unit 42 may utilize any conventional means of electrical communication with the vehicle 32. The detection unit 42 issues an audible alarm such that the detection unit 42 prevents the child 30 from being left within the vehicle 32 after the vehicle 32 is turned off.

The detection unit 42 comprises a control circuit 44 that is positioned within the housing 12. The control circuit 42 is electrically coupled to the lock 38 such that the control circuit 42 is notified when the housing 12 is coupled between the male end 26 and the female end 36 of the vehicle seatbelt 28. The control circuit 44 selectively generates an alarm sequence. The control circuit 44 is in electrical communication with the vehicle 32 thereby facilitating the control circuit 44 to detect when the vehicle 32 is turned on and off. Thus, the control circuit 44 generates the alarm sequence when the housing 12 is coupled between the male end 26 and the female end 36 and when the vehicle 32 is turned off. The control circuit 44 includes a timer 46 and the timer 46 delays the alarm sequence until a pre-determined amount of time has passed.

A speaker 48 is coupled to the bottom wall 16 and the speaker 48 is electrically coupled to the control circuit 42. The speaker 48 emits an audible alarm when the control circuit 48 generates the alarm sequence. Thus, the speaker 48 issues an audible alert that the child 30 has been left unattended in the vehicle 32.

A power supply 50 is positioned within the housing 12 and the power supply 50 is electrically coupled to the control circuit 42. The power supply 50 comprises at least one battery 52. A battery cover 54 is removably coupled to the bottom wall 16. The power supply 50 is positioned beneath the battery cover 54.

A pair of light emitters 56 is provided and each of the light emitters 56 is positioned on the top wall 14 of the housing 12. Each of the light emitters 56 is electrically coupled to the control circuit 42 and each of the light emitters 56 selectively emits light to indicate a functional status of the control circuit 42. The pair of light emitters 56 includes a low charge light emitter 58 and an on light emitter 60. The low charge light emitter 58 emits light when the power supply 50 falls below a pre-determined amount of charge. The on light emitter 60 emits light when the housing 12 is coupled between the male end 26 and the female end 36 of the vehicle seatbelt 28.

In use, the male end 26 of the vehicle seatbelt 28 is inserted into the well 24 and the buckle 34 is manipulated to engage the female end 36 of the vehicle seatbelt 28. Thus, the housing 12 is coupled between the male end 26 and the female end 36. The timer 46 begins counting the pre-determined amount of time when the vehicle 32 is turned off and the housing 12 has been coupled between the male end 26 and the female end 36. The control circuit 42 generates the alarm sequence after the pre-determined amount of time has passed and the speaker 48 emits the audible alarm. The speaker 48 continuously emits the audible alarm until the housing 12 is uncoupled from the vehicle seatbelt 28 thereby preventing the child 30 from being inadvertently left in the vehicle 32.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A child safety assembly configured to issue an alarm when a child is left unattended in a vehicle, said assembly comprising:
a housing being configured to insertably receive a male end of a vehicle seatbelt;
a buckle being attached to said housing wherein said buckle is configured to engage a female end of the vehicle seatbelt such that said housing is retained between the male end of the vehicle seatbelt and the female end of the vehicle seat belt when the vehicle seatbelt is utilized to restrain a child in the vehicle; and
a detection unit being positioned within said housing, said detection unit being configured to be in communication with the vehicle such that said detection unit detects when the vehicle is turned on and off, said detection issuing an audible alarm wherein said detection unit is configured to prevent a child from being left within the vehicle after the vehicle is turned off.

2. The assembly according to claim 1, wherein said housing has a top wall, a bottom wall and a peripheral wall extending between said top wall and said bottom wall, said peripheral wall having a front side and a back side, said back side having a well extending inwardly therein wherein said well is configured to insertably receive the male end of the vehicle seatbelt.

3. The assembly according to claim 1, further comprising a lock being coupled to said housing wherein said lock is configured to engage the male end of the vehicle seatbelt such that the vehicle seatbelt is removably coupled to said housing.

4. The assembly according to claim 3, further comprising:
said housing having a top wall; and
a release being coupled to said housing, said release being positioned on said top wall wherein said release is configured to be manipulated, said release being mechanically coupled to said lock wherein said release is configured to release the male end from said housing when said release is manipulated.

5. The assembly according to claim 1, further comprising:
a lock; and
said detection unit comprising a control circuit being positioned within said housing, said control circuit being electrically coupled to said lock wherein said control circuit is configured to be notified when said housing is coupled between the male end and the female end of the vehicle seatbelt.

6. The assembly according to claim 5, wherein said control circuit selectively generates an alarm sequence, said control circuit being configured to be in electrical communication with the vehicle thereby facilitating said control circuit to detect when the vehicle is turned on and off such that said control circuit generates said alarm sequence when said housing is coupled between the male end and the female end and when the vehicle is turned off, said control circuit including a timer, said timer delaying said alarm sequence until a pre-determined amount of time has passed.

7. The assembly according to claim 6, further comprising:
said housing having a bottom wall; and
a speaker being coupled to said bottom wall, said speaker being electrically coupled to said control circuit, said speaker emitting an audible alarm when said control circuit generates said alarm sequence wherein said speaker is configured to issue an alert that the child has been left unattended in the vehicle.

8. The assembly according to claim 7, further comprising a power supply being positioned within said housing, said power supply being electrically coupled to said control circuit, said power supply comprising at least one battery.

9. The assembly according to claim 8, further comprising a pair of light emitters, each of said light emitters being positioned on said top wall of said housing, each of said light emitters being electrically coupled to said control circuit, each of said light emitters selectively emitting light to indicate a functional status of said control circuit.

10. A child safety assembly configured to issue an alarm when a child is left unattended in a vehicle, said assembly comprising:
a housing having a top wall, a bottom wall and a peripheral wall extending between said top wall and said bottom wall, said peripheral wall having a front side and a back side, said back side having a well extending inwardly therein wherein said well is configured to insertably receive a male end of a vehicle seatbelt;
a buckle being attached to said housing, said buckle being positioned on and extending away from said front side of said housing wherein said buckle is configured to engage a female end of the vehicle seatbelt such that said housing is retained between the male end of the vehicle seatbelt and the female end of the vehicle seat belt when the vehicle seatbelt is utilized to restrain a child in the vehicle;
a lock being coupled to said housing wherein said lock is configured to engage the male end of the vehicle seatbelt such that the vehicle seatbelt is removably coupled to said housing;
a release being coupled to said housing, said release being positioned on said top wall wherein said release is configured to be manipulated, said release being mechanically coupled to said lock wherein said release is configured to release the male end from said housing when said release is manipulated; and
a detection unit being positioned within said housing, said detection unit being configured to be in communication with the vehicle such that said detection unit detects when the vehicle is turned on and off, said detection issuing an audible alarm wherein said detection unit is configured to prevent a child from being left within the vehicle after the vehicle is turned off, said detection unit comprising:
a control circuit being positioned within said housing, said control circuit being electrically coupled to said lock wherein said control circuit is configured to be notified when said housing is coupled between the male end and the female end of the vehicle seatbelt, said control circuit selectively generating an alarm sequence, said control circuit being configured to be in electrical communication with the vehicle thereby facilitating said control circuit to detect when the vehicle is turned on and off such that said control circuit generates said alarm sequence when said housing is coupled between the male end and the female end and when the vehicle is turned off, said control circuit including a timer, said timer delaying said alarm sequence until a pre-determined amount of time has passed,
a speaker being coupled to said bottom wall, said speaker being electrically coupled to said control circuit, said speaker emitting an audible alarm when said control circuit generates said alarm sequence wherein said speaker is configured to issue an alert that the child has been left unattended in the vehicle,
a power supply being positioned within said housing, said power supply being electrically coupled to said control circuit, said power supply comprising at least one battery, and
a pair of light emitters, each of said light emitters being positioned on said top wall of said housing, each of said light emitters being electrically coupled to said control circuit, each of said light emitters selectively emitting light to indicate a functional status of said control circuit.
